(19) United States
(12) Patent Application Publication
(10) Pub. No.: US 2025/0061751 A1
(43) Pub. Date: Feb. 20, 2025

(54) PARKING LOT MANAGEMENT SYSTEM, PARKING LOT MANAGEMENT METHOD, AND NON-TRANSITORY COMPUTER READABLE MEDIUM STORING PARKING LOT MANAGEMENT PROGRAM

(71) Applicant: NEC Corporation, Minato-ku, Tokyo (JP)

(72) Inventor: Tomoaki TANAKA, Tokyo (JP)

(73) Assignee: NEC Corporation, Minato-ku, Tokyo (JP)

(21) Appl. No.: 18/721,242

(22) PCT Filed: Dec. 22, 2021
(86) PCT No.: PCT/JP2021/047632

§ 371 Date: Jun. 18, 2024

(51) Int. Cl. G07B 15/02; G06F 21/32; G06V 40/16

(52) U.S. Cl. CPC G07B 15/02; G06F 21/32; G06V 40/166

(57) ABSTRACT

A parking lot terminal includes a face image acquisition unit acquires a first face image obtained by capturing an image of a user who drives a vehicle entering a parking lot and a second face image obtained by capturing an image of a user who drives a vehicle exiting the parking lot, and a server includes: a user information storage unit stores identification information on a user, registered face information, and destination information in advance; an entry processing unit transmits, when a vehicle enters the parking lot, temporary password information to a user terminal and stores identification information and password information in an entry information storage unit; and an exit processing unit performs authentication, when the vehicle exits the parking lot, using the temporary password information when identification information on the exiting user is not stored in the entry information storage unit.

### TECHNICAL FIELD

The present invention relates to a parking lot management system, a parking lot management method, and a non-transitory computer readable medium storing a parking lot management program.

### BACKGROUND ART

With the spread of the use of car sharing services and the spread of self-driving vehicles, it is expected that the number of automobiles and the number of parking lots owned by individuals will decrease while the demand for paid parking lots such as hourly parking lots will increase.

In the hourly parking lots, however, there have been problems such as the cost of installing payment equipment and issuing parking tickets, users losing their parking tickets, and users pulling their vehicles too close to the payment equipment when parking tickets are issued and the users make payments, resulting in accidents involving contact between vehicles and the payment equipment.

Patent Literature 1 discloses a parking lot management system which does not require management of parking lots using parking tickets. Specifically, in the parking lot management system disclosed in Patent Literature 1, a face of a driver of a vehicle entering a parking lot is imaged to create face data, and this face data as well as time information are accumulated in a database. Further, when the vehicle leaves the parking lot, the face of the driver is imaged to create face data, and this face data is compared with the face data accumulated in the database. Then, the parking fee which is based on time information associated with the face data that matches the face data captured when the vehicle leaves the parking lot among the face data accumulated in the database is informed, and the vehicle is allowed to leave after the payment is made.

### CITATION LIST

### Patent Literature

[Patent Literature 1] Japanese Unexamined Patent Application Publication No. 2006-338479

### SUMMARY OF INVENTION

### Technical Problem

However, in the method disclosed in Patent Literature 1, if the face data captured when a user driving a vehicle enters the parking lot does not match the face data captured when the user driving a vehicle leaves the parking lot, the user cannot pay the fee. Therefore, it is possible, for example, that a problem may occur when, for example, a husband driving a vehicle enters the parking lot but his wife driving the same vehicle leaves the parking lot.

An object of the present disclosure is to provide a parking lot management system, a parking lot management method, and a non-transitory computer readable medium storing a parking lot management program capable of further improving convenience.

### Solution to Problem

A parking lot management system according to a first aspect of the present invention includes: a parking lot terminal installed in a parking lot, a user terminal owned by a user, and a server that can communicate with the parking lot terminal and the user terminal, in which the parking lot terminal includes: a face image acquisition unit configured to acquire a first face image obtained by capturing an image of a user who drives a vehicle entering the parking lot and a second face image obtained by capturing an image of a user who drives a vehicle leaving the parking lot, in which the server includes: a user information storage unit configured to store at least identification information on a user, registered face information of the user, and destination information of the user terminal owned by the user in association with one another in advance: an entry processing unit configured to determine, when a vehicle enters the parking lot, whether or not the first face image matches the registered face information stored in the user information storage unit, and transmit, when they match each other, temporary password information to the user terminal and store, as entry information, at least the identification information and the temporary password information associated with each other in an entry information storage unit; and an exit processing unit configured to determine, when a vehicle leaves the parking lot, whether or not the second face image matches the registered face information stored in the user information storage unit, perform, when they match each other and the identification information on the user at the time of exit is stored in the entry information storage unit, processing for paying a parking fee for the user associated with the registered face information, acquire, when they match each other and the identification information on the user at the time of exit is not stored in the entry information storage unit, the temporary password information input by the user on the parking lot terminal, and perform, when the acquired temporary password information matches the temporary password information stored in the entry information storage unit, processing for paying the parking fee for the user associated with the temporary password information.

A parking lot management method according to a second aspect of the present invention, in which a server that can communicate with a parking lot terminal installed in a parking lot and a user terminal owned by a user: stores at least identification information on a user, registered face information of the user, and destination information of the user terminal owned by the user in association with one another in advance; determines, when a vehicle enters the parking lot, whether or not a first face image obtained by capturing an image of the user who drives the vehicle entering the parking lot, the first face image being acquired by the parking lot terminal, matches the registered face information, and transmits, when they match each other, temporary password information to the user terminal and stores, as entry information, at least the identification information and the temporary password information associated with each other: and determines, when a vehicle leaves the parking lot, whether or not a second face image obtained by capturing an image of the user who drives the vehicle leaving the parking lot, the second face image being acquired by the parking lot terminal, matches the registered face information, performs, when they match each other and the identification information on the user at the time of exit is included in the entry information, processing for paying a parking fee for the user associated with the registered face information, acquires, when they match each other and the identification information on the user at the time of exit is not included in the entry information, the temporary password information input by the user on the parking lot terminal, and performs, when the acquired temporary password information matches the stored temporary password information, processing for paying the parking fee for the user associated with the temporary password information.

A non-transitory computer readable medium storing a parking lot management program according to a third aspect of the present invention stores a parking lot management program causing a server that can communicate with a parking lot terminal installed in a parking lot and a user terminal owned by a user to execute: processing for storing at least identification information on a user, registered face information of the user, and destination information of the user terminal owned by the user in association with one another; processing for determining, when a vehicle enters the parking lot, whether or not a first face image obtained by capturing an image of the user who drives the vehicle entering the parking lot, the first face image being acquired by the parking lot terminal, matches the registered face information, and transmitting, when they match each other, temporary password information to the user terminal and storing, as entry information, at least the identification information and the temporary password information associated with each other; and processing for determining, when a vehicle leaves the parking lot, whether or not a second face image obtained by capturing an image of the user who drives the vehicle leaving the parking lot, the second face image being acquired by the parking lot terminal, matches the registered face information, performing, when they match each other and the identification information on the user at the time of exit is included in the entry information, processing for paying a parking fee for the user associated with the registered face information, acquiring, when they match each other and the identification information on the user at the time of exit is not included in the entry information, the temporary password information input by the user on the parking lot terminal, and performing, when the acquired temporary password information matches the stored temporary password information, processing for paying the parking fee for the user associated with the temporary password information.

### Advantageous Effects of Invention

It is possible to provide a parking lot management system, a parking lot management method, and a non-transitory computer readable medium storing a parking lot management program capable of further improving convenience.

### BRIEF DESCRIPTION OF DRAWINGS

FIG. 1 is a block diagram showing one example of a parking lot management system according to the present invention;

FIG. 2 is a block diagram showing one example of a parking lot management system according to a first example embodiment of the present invention;

FIG. 3 is a diagram showing one example of a data table of a user information storage unit according to the first example embodiment of the present invention;

FIG. 4 is a diagram showing another example of the data table of the user information storage unit according to the first example embodiment of the present invention;

FIG. 5 is a diagram showing one example of a data table of an entry information storage unit according to the first example embodiment of the present invention;

FIG. 6 is a diagram showing one example of a data table of a purchase history storage unit according to the first example embodiment of the present invention;

FIG. 7 is a flowchart showing one example of a parking lot management method according to the first example embodiment of the present invention;

FIG. 8 is a flowchart showing one example of the parking lot management method according to the first example embodiment of the present invention; and

FIG. 9 is a diagram showing one example of a parking lot terminal according to the first example embodiment of the present invention.

### EXAMPLE EMBODIMENT

Hereinafter, with reference to the drawings, an example embodiment of the present invention will be described.

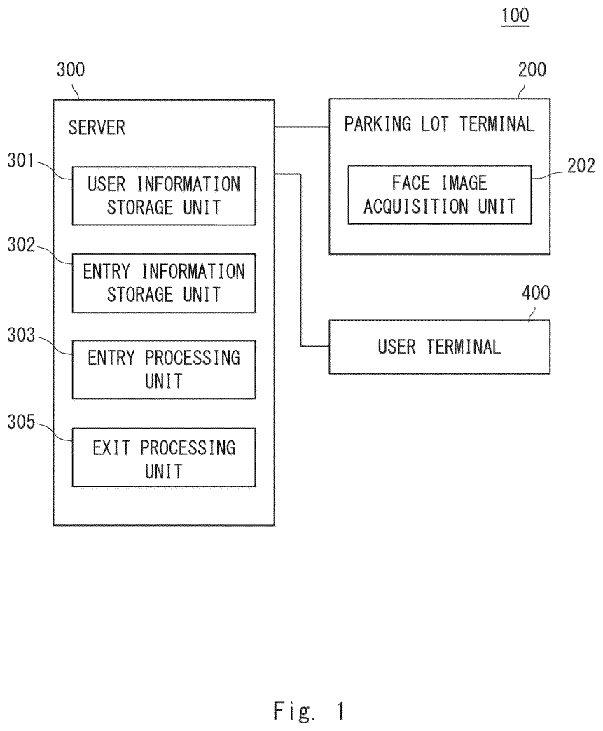

FIG. 1 is a block diagram showing one example of a parking lot management system 100 according to the present invention. As shown in FIG. 1, the parking lot management system 100 includes a parking lot terminal 200 installed in a parking lot, a server 300, and a user terminal 400 owned by a user. Further, the server 300 can communicate with the parking lot terminal 200 and the user terminal 400.

The parking lot terminal 200 includes a face image acquisition unit 202.

The face image acquisition unit 202 acquires a first face image obtained by capturing an image of a user who drives a vehicle entering a parking lot and a second face image obtained by capturing an image of a user who drives a vehicle leaving the parking lot.

The server 300 includes a user information storage unit 301, an entry information storage unit 302, an entry processing unit 303, and an exit processing unit 305.

The user information storage unit 301 stores user information in advance. The user information is information in which at least identification information on a user, registered face information of the user, and destination information of a user terminal 400 owned by the user are associated with one another. Here, the registered face information may be a face image of the user or may be features extracted from the face image. Further, the destination information is, for example, a mail address or the like of the user terminal 400 owned by the user.

The entry information storage unit 302 stores entry information. The entry information is information in which at least identification information on the user and temporary password information (described later) are associated with each other. Note that, when the server 300 manages a plurality of parking lots or a plurality of entrances, the entry information may include identification information of the parking lot terminals.

The entry processing unit 303 determines, when a vehicle enters the parking lot, whether or not the first face image acquired by the parking lot terminal 200 matches the registered face information stored in the user information storage unit 301.

Further, when the first face image acquired by the parking lot terminal 200 matches the registered face information stored in the user information storage unit 301, the entry processing unit 303 transmits the temporary password information to the user terminal 400 of the user, and stores the entry information in the entry information storage unit 302. Here, the password information is, for example, a character string in which letters, numbers, symbols or the like are combined with each other.

The exit processing unit 305 determines, when a vehicle leaves the parking lot, whether or not the second face image acquired by the parking lot terminal 200 matches the registered face information stored in the user information storage unit 301.

Further, the exit processing unit 305 performs, when the second face image acquired by the parking lot terminal 200 matches the registered face information stored in the user information storage unit 301 and identification information on the user at the time of exit is stored in the entry information storage unit 302, processing for paying the parking fee for the user associated with the registered face information in the user information storage unit 301. Specifically, the exit processing unit 305 first determines whether or not the second face image acquired by the parking lot terminal 200 matches the registered face information stored in the user information storage unit 301. When the second face image matches the registered face information stored in the user information storage unit 301, the exit processing unit 305 acquires identification information that corresponds to the registered face information from the user information storage unit 301 as identification information on the user at the time of exit. Next, the exit processing unit 305 determines whether or not the identification information is stored in the entry information storage unit 302. Then, when the identification information is stored in the entry information storage unit 302, the exit processing unit 305 performs processing for paying the parking fee for the user associated with the registered face information in the user information storage unit 301.

Further, the exit processing unit 305 acquires, when the second face image acquired by the parking lot terminal 200 matches the registered face information stored in the user information storage unit 301 and the identification information on the user at the time of exit is not stored in the entry information storage unit 302, the temporary password information input by the user on the parking lot terminal, and performs, when the acquired temporary password information matches the temporary password information stored in the entry information storage unit 302, processing for paying the parking fee for the user associated with the temporary password information.

With the parking lot management system 100 according to the present invention described above, the user information storage unit 301 stores user information in which at least identification information on the user, registered face information of the user, and destination information of the user terminal 400 owned by the user are associated with one another in advance. Further, the face image acquisition unit 202 of the parking lot terminal 200 acquires a first face image obtained by capturing an image of a user who drives the vehicle entering the parking lot and a second face image obtained by capturing an image of a user who drives the vehicle leaving the parking lot. Further, when the first face image matches the registered face information, the server 300 transmits temporary password information to the user terminal 400. Then, when the second face image matches the registered face information and the identification information on the user at the time of exit is not stored in the entry information storage unit 302, the server 300 performs authentication using the temporary password information. In other words, when the user who has his/her vehicle leave the parking lot is the user stored in the user information storage unit 301 in advance and is different from the user who has his/her vehicle enter the parking lot, the server 300 performs authentication using the temporary password information. Therefore, even when the user who has his/her vehicle enter the parking lot is different from the user who has his/her vehicle leave the parking lot, the server 300 may perform payment processing. Accordingly, it is possible to provide a parking lot management system 100 capable of further improving convenience.

### First Example Embodiment

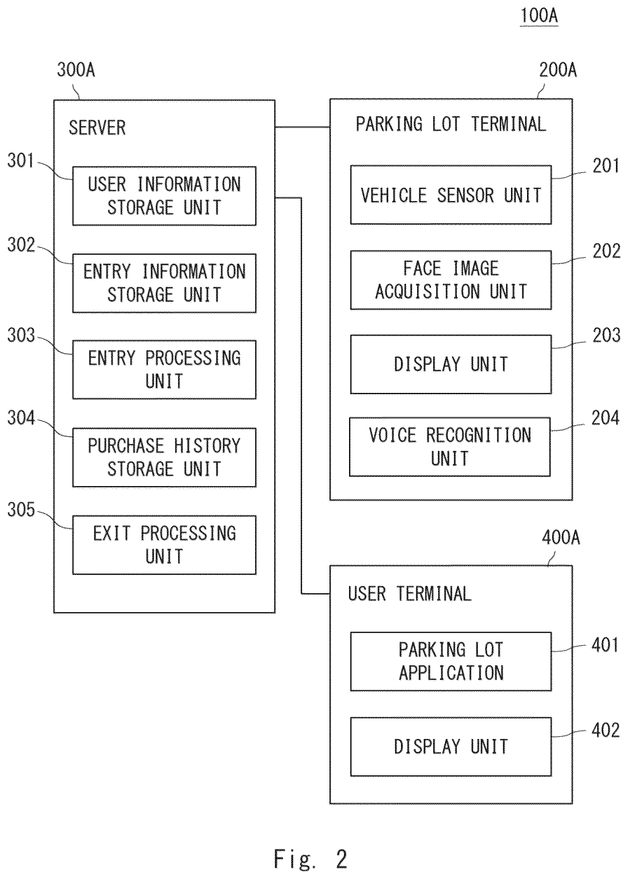

A parking lot management system 100A according to a first example embodiment of the present invention will be described. FIG. 2 is a diagram showing one example of the parking lot management system 100A according to the first example embodiment. As shown in FIG. 2, the parking lot management system 100A includes a parking lot terminal 200A installed in a parking lot, a server 300A, and a user terminal 400A owned by the user. Further, the server 300A can communicate with the parking lot terminal 200A and the user terminal 400A. The server 300A can communicate with a plurality of user terminals 400, although this form is not shown in FIG. 2. Further, the server 300A and the plurality of parking lot terminals 200A can communicate with each other. That is, the server 300A may perform parking lot management in a plurality of parking lots.

The parking lot terminal 200A includes a vehicle sensor unit 201, a face image acquisition unit 202, a display unit 203, and a voice recognition unit 204. The parking lot terminal 200A is installed, for example, in each of the entrance of the parking lot which vehicles enter and the exit of the parking lot from which vehicles leave. When the entrance of the parking lot which the vehicles enter is the same as the exit of the parking lot from which the vehicles leave, the parking lot terminal 200A is installed in the entrance and the exit of the parking lot. Further, the parking lot terminal 200A may be installed near a side entrance which users of the parking lot pass. Further, the parking lot terminal 200A may be a tablet terminal installed in each of these places.

The vehicle sensor unit 201 detects vehicles entering the parking lot and vehicles leaving the parking lot. The vehicle sensor unit 201 is, for example, a sound wave sensor provided in the entrance and the exit of the parking lot. When the vehicle sensor unit 201 detects a vehicle, the parking lot terminal 200A transmits a parking lot terminal ID 302A (described later) of the parking lot terminal 200A in association with a vehicle detection signal to the server 300A.

The face image acquisition unit 202 acquires a first face image obtained by capturing an image of a user who drives a vehicle entering the parking lot and a second face image obtained by capturing an image of a user who drives a vehicle leaving the parking lot. The face image acquisition unit 202 is, for example, a camera installed in the entrance and the exit of the parking lot. The parking lot terminal 200A transmits the first face image and the second face image acquired by the face image acquisition unit 202 in association with the parking lot terminal ID 302A to the server 300A. More specifically, the parking lot terminal 200A transmits the first face image in which an entry flag is set in association with the parking lot terminal ID 302A to the server 300A. The parking lot terminal 200A further transmits the second face image in which an exit flag is set in association with the parking lot terminal ID 302A to the server 300A. By setting the entry flag or the exit flag, the server 300A can identify whether or not the face image transmitted from the parking lot terminal 200A is the first face image or the second face image.

The display unit 203, which is, for example, a liquid crystal display, an organic EL display or the like, displays a parking fee, etc. Further, the display unit 203 may be a touch panel display and display predetermined matters in such a way that they can be selected.

The voice recognition unit 204 recognizes a user's voice. The user may input predetermined matters to the parking lot terminal 200A by voice. For example, the user may input temporary password information to the parking lot terminal 200A by voice. Accordingly, it is possible to prevent the user from touching the display unit 203, which is a touch display, and to improve the convenience for the user. It is further possible to prevent infectious diseases. The parking lot terminal 200 transmits a voice signal which is based on the voice recognized by the voice recognition unit 204 in association with the parking lot terminal ID 302A to the server 300A.

The server 300A includes a user information storage unit 301, an entry information storage unit 302, an entry processing unit 303, a purchase history storage unit 304, and an exit processing unit 305.

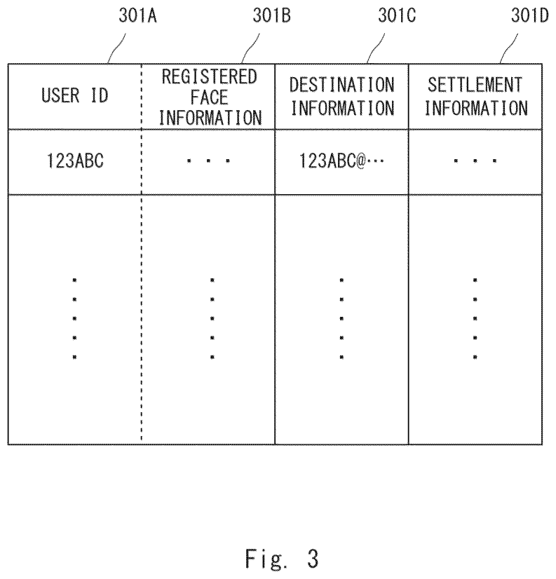

The user information storage unit 301 stores user information in advance. FIG. 3 shows one example of a data table of the user information storage unit 301. As shown in FIG. 3, the user information storage unit 301 stores, as user information, for example, a user ID 301A, which is identification information on the user, registered face information 301B of the user, destination information 301C of the user terminal 400A owned by the user, and settlement information 301D that is necessary for the user to make a payment for the parking fee in association with one another. Here, the user ID 301A is, for example, a character string in which letters, numbers, symbols or the like for identifying the user are combined with each other. Further, the settlement information 301D is information such as a card number with which the user can pay the parking fee. Further, the registered face information 301B may be the face image of the user or may be features extracted from the face image. Further, the features may be extracted using, for example, an algorithm such as Scale-Invariant Feature Transform (SIFT) or Histograms of Oriented Gradients (HOG). Further, the destination information 301C may be, for example, the mail address, the telephone number or the like of the user terminal 400 owned by the user. In the following description, an example in which a mail address is used as the destination information 301C will be described.

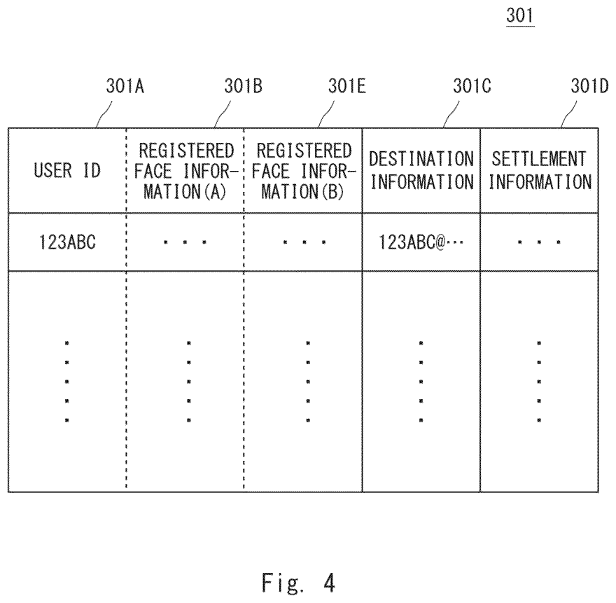

Further, the user information storage unit 301 may store registered face information of a plurality of users in association with one user ID 301A, one piece of destination information 301C, and one piece of settlement information 301D. For example, as shown in FIG. 4, the user information storage unit 301 may store one user ID 301A, registered face information (A) 301B and registered face information (B) 301E, one piece of destination information 301C, and one piece of settlement information 301D in association with one another. Accordingly, when, for example, one vehicle is used by a married couple, there is no need for the husband and his wife to separately register user information in the server 300A in advance. Note that the number of pieces of registered face information stored in the user information storage unit 301 in association with one user ID 301A, one piece of destination information 301C, and one piece of settlement information 301D is not limited to those shown in FIGS. 3 and 4, and registered face information of three or more persons may be naturally stored.

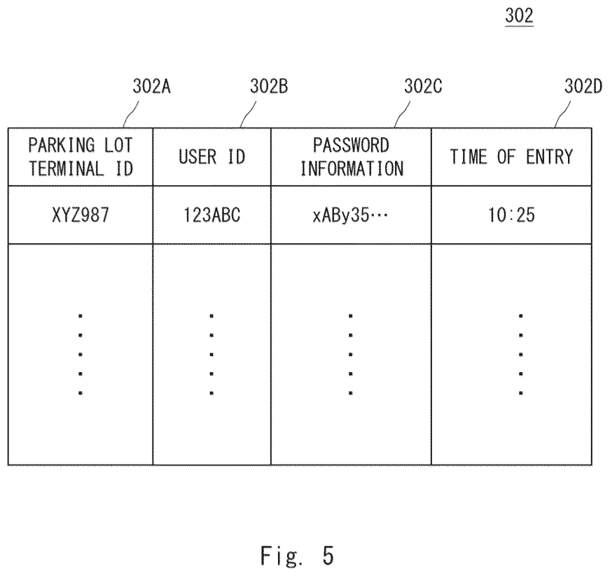

The entry information storage unit 302 stores entry information. FIG. 5 shows one example of a data table of the entry information storage unit 302. As shown in FIG. 5, the entry information storage unit 302 stores, as entry information, for example, a parking lot terminal ID 302A, which is identification information of the parking lot terminal 200A, a user ID 302B, temporary password information 302C (described later), and a time of entry 302D, which is the time when the vehicle has entered the parking lot, in association with one another. Here, the parking lot terminal ID 302A is a character string in which letters, numbers, symbols or the like for identifying the parking lot terminal 200A are combined with each other. It is assumed that, even when different parking lot terminals 200A are installed in the entrance and the exit of the parking lot, as long as these parking lot terminals 200A are installed in the same parking lot, the parking lot terminal IDs 302A of the parking lot terminals 200A are the same.

The entry processing unit 303 determines, when a vehicle enters the parking lot, whether or not the first face image acquired by the parking lot terminal 200A matches the registered face information 301B stored in the user information storage unit 301. Specifically, the entry processing unit 303 determines, when the vehicle detection signal and the first face image have been transmitted from the parking lot terminal 200A, whether or not the first face image matches the registered face information 301B stored in the user information storage unit 301. The entry processing unit 303 performs processing for authenticating the first face image when the vehicle detection signal has been transmitted. It is therefore possible to prevent, for example, erroneous entry processing from being performed when a user who has got out of a vehicle passes in front of the parking lot terminal 200A to retrieve a forgotten item left in the vehicle and thus the face image of this user has been captured.

Further, when registered face information (for example, registered face information (A) 301B, registered face information (B) 301E) of a plurality of users associated with one user ID 301A is stored in the user information storage unit 301, as shown in FIG. 4, the entry processing unit 303 may determine which one of the plurality of pieces of registered face information the first face image matches.

When the first face image acquired by the parking lot terminal 200A matches the registered face information 301B stored in the user information storage unit 301, the entry processing unit 303 transmits the temporary password information 302C to the user terminal 400A of the user and stores the entry information in the entry information storage unit 302. Specifically, the server 300A transmits the temporary password information to the mail address 301C associated with the registered face information 301B stored in the user information storage unit 301. Here, the password information 302C is, for example, a character string in which letters, numbers, symbols or the like are combined with each other. Note that the entry processing unit 303 may generate the temporary password information 302C for each parking lot terminal 200A. Further, the server 300A stores, as entry information, the parking lot terminal ID 302A of the parking lot terminal 200A, the user ID 302B, the temporary password information 302C, and the time of entry 302D in the entry information storage unit 302. Note that the server 300A stores, as the user ID 302B, the user ID 301A associated with the registered face information 301B in the entry information storage unit 302.

When the first face image acquired by the parking lot terminal 200A does not match the registered face information 301B stored in the user information storage unit 301, the entry processing unit 303 may register the user information and then the aforementioned entry processing. Specifically, the entry processing unit 303 causes, for example, the display unit 203 of the parking lot terminal 200A to display input fields for enabling the user to enter the mail address 301C and the settlement information 301D. Then, the entry processing unit 303 stores the user ID 301A, the registered face information 301B, which is the first face image or features extracted from the first face image, the mail address 301C entered by the user into the input fields, and the settlement information 301D entered by the user into the input fields in the user information storage unit 301 in such a way that they are associated with one another. After that, the entry processing unit 303 transmits the temporary password information 302C to the user terminal 400A and stores the entry information in the entry information storage unit 302 in a manner similar to that described above.

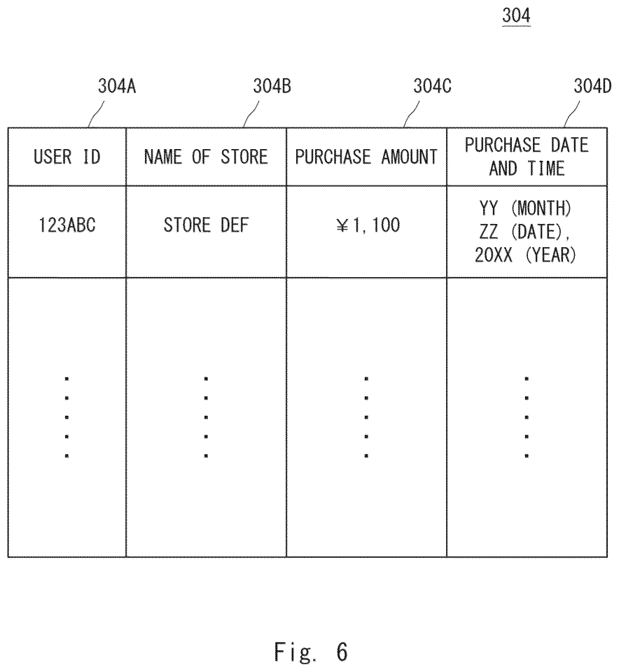

The purchase history storage unit 304 stores a history of purchase made by a user who has parked his/her vehicle in a parking lot in a store which is in alliance with the parking lot while the user has his/her vehicle parked in the parking lot in association with the user ID, which is the identification information on the user. FIG. 6 shows one example of a data table of the purchase history storage unit 304. As shown in FIG. 6, the purchase history storage unit 304 stores, for example, a user ID 304A, a name of the store 304B where the user has made the purchase, a purchase amount 304C, and a purchase date and time 304D in association with one another. Specifically, the server 300A can communicate with a store terminal (not shown) installed in this store, and when the user makes a purchase in this store, the user ID 304A, the name of the store 304B, the purchase amount 304C, and the purchase date and time 304D, which are associated with one another, are transmitted from the above store terminal to the server 300A. The user ID 304A of the user may be transmitted from the user terminal 400A to the store terminal when the user makes a purchase in this store.

The exit processing unit 305 determines, when a vehicle leaves the parking lot, whether or not the second face image acquired by the parking lot terminal 200A matches the registered face information 301B stored in the user information storage unit 301. Specifically, the exit processing unit 305 determines, when the vehicle detection signal and the second face image have been transmitted from the parking lot terminal 200A, whether or not the second face image matches the registered face information 301B stored in the user information storage unit 301. The exit processing unit 305 performs processing for authenticating the second face image when a vehicle detection signal has been transmitted. It is therefore possible to prevent, for example, when a user who has got out of a vehicle passes in front of the parking lot terminal 200A to retrieve a forgotten item left in the vehicle and thus the face image of this user has been captured, exit processing from being erroneously performed.

When the second face image acquired by the parking lot terminal 200A matches the registered face information 301B stored in the user information storage unit 301 and the user ID of the user at the time of exit is stored in the entry information storage unit 302, the exit processing unit 305 performs the processing for paying the parking fee for the user associated with the registered face information 301B in the user information storage unit 301. Specifically, the exit processing unit 305 first determines whether or not the second face image acquired by the parking lot terminal 200 matches the registered face information 301B stored in the user information storage unit 301. When the second face image matches the registered face information 301B stored in the user information storage unit 301, the exit processing unit 305 acquires, from the user information storage unit 301, the user ID 301A associated with the registered face information 301B as the user ID of the user at the time of exit. Next, the exit processing unit 305 determines whether or not the user ID 301A is included in the user ID 302B stored in the entry information storage unit 302. Then, when the user ID 301A is included in the user ID 302B stored in the entry information storage unit 302, the exit processing unit 305 performs the processing for paying the parking fee using the settlement information 301D associated with the user ID 301A in the user information storage unit 301.

Further, the exit processing unit 305 determines the parking fee based on the time of entry 302D stored in the entry information storage unit 302, the purchase history stored in the purchase history storage unit 304, and the time of exit (current time). Specifically, the exit processing unit 305 searches for the entry information storage unit 302 based on the parking lot terminal ID 302A of the parking lot terminal 200A and the user ID 302B which is the same as the user ID 301A associated with the registered face information 301B. Then, the exit processing unit 305 determines the parking fee based on the time of entry 302D associated with the parking lot terminal ID 302A and the user ID 302B in the entry information storage unit 302 and the time of exit (current time). Further, the exit processing unit 305 searches, for example, the purchase history storage unit 304 for the user ID 304A which is the same as the user ID 301A associated with the registered face information 301B. Then, the exit processing unit 305 performs processing for discounting the parking fee in accordance with the purchase amount 304C and the purchase date and time 304D associated with the user ID 304A in the purchase history storage unit 304.

When the second face image acquired by the parking lot terminal 200A matches the registered face information 301B stored in the user information storage unit 301 and the user ID 302B of the user at the time of exit is not stored in the entry information storage unit 302, the exit processing unit 305 acquires the temporary password information entered by the user into the parking lot terminal 200A. Specifically, the exit processing unit 305 causes the display unit 203 of the parking lot terminal 200A to display a message for requesting the user to enter the temporary password information and an input field for enabling the user to enter the temporary password information. Note that the input of the temporary password information to the parking lot terminal 200A by the user may be performed by voice. Further, when the temporary password information 302C is generated for each parking lot terminal 200A in the entry processing, the exit processing unit 305 also acquires the parking lot terminal ID from the parking lot terminal 200A.

Further, when the second face image acquired by the parking lot terminal 200A does not match the registered face information 301B stored in the user information storage unit 301, the exit processing unit 305 acquires the temporary password information entered by the user into the parking lot terminal 200A in a manner similar to that described above.

Then, the exit processing unit 305 determines whether or not the acquired temporary password information matches the temporary password information 302C stored in the entry information storage unit 302. When they match each other, the exit processing unit 305 performs the processing for paying the parking fee for the user associated with the temporary password information 302C. Note that, when the temporary password information 302C is generated for each parking lot terminal 200A in the entry processing, the exit processing unit 305 determines whether or not the acquired temporary password information and the parking lot terminal ID match the temporary password information 302C and the parking lot terminal ID 302A stored in the entry information storage unit 302. Then, the exit processing unit 305 searches the user information storage unit 301 for the user ID 301A which is the same as the user ID 302B associated with the temporary password information 302C. Then, the exit processing unit 305 performs the processing for paying the parking fee in the user information storage unit 301 using the settlement information 301D associated with the user ID 301A.

Further, the exit processing unit 305 determines the parking fee based on the time of entry 302D stored in the entry information storage unit 302, the purchase history stored in the purchase history storage unit 304, and the time of exit (current time). Specifically, the exit processing unit 305 determines the parking fee based on the time of entry 302D associated with the temporary password information 302C in the entry information storage unit 302 and the time of exit (current time). Further, the exit processing unit 305 searches the purchase history storage unit 304 for the user ID 304A which is the same as the user ID 302B associated with the temporary password information 302C. Then, the exit processing unit 305 performs processing for discounting the parking fee in accordance with the purchase amount 304C and the purchase date and time 304D associated with the user ID 304A in the purchase history storage unit 304.

Further, when the processing for paying the parking fee is completed, the exit processing unit 305 deletes the entry information from the entry information storage unit 302. Alternatively, when the processing for paying the parking fee is completed, the exit processing unit 305 may associate a parking lot terminal ID 302A for which payment processing has been completed, the user ID 302B, temporary password information 302C, and a time of entry 302D with one another in the entry information storage unit 302 and set a corresponded flag. The entry information in which the corresponded flag is set will be excluded from the next search target of the exit processing unit 305.

The user terminal 400A includes a parking lot application 401, which is an application for using the parking lot management system 100A, and a display unit 402. The user terminal 400A may execute the parking lot application 401 so that the display unit 402 may be caused to display the temporary password information transmitted from the server 300A. Further, the user terminal 400A may execute the parking lot application 401 so that user information may be registered in the server 300A. Specifically, the user terminal 400A may execute the parking lot application 401 so that the user terminal 400A may transmit the registered face information 301B, the mail address 301C, and the settlement information 301D to the server 300A and the server 300A may store these information items in the user information storage unit 301. Further, the user terminal 400A executes the parking lot application 401 so that, when the user makes a purchase in a store, the user terminal 400A may transmit identification information on the user (user ID) to the store terminal.

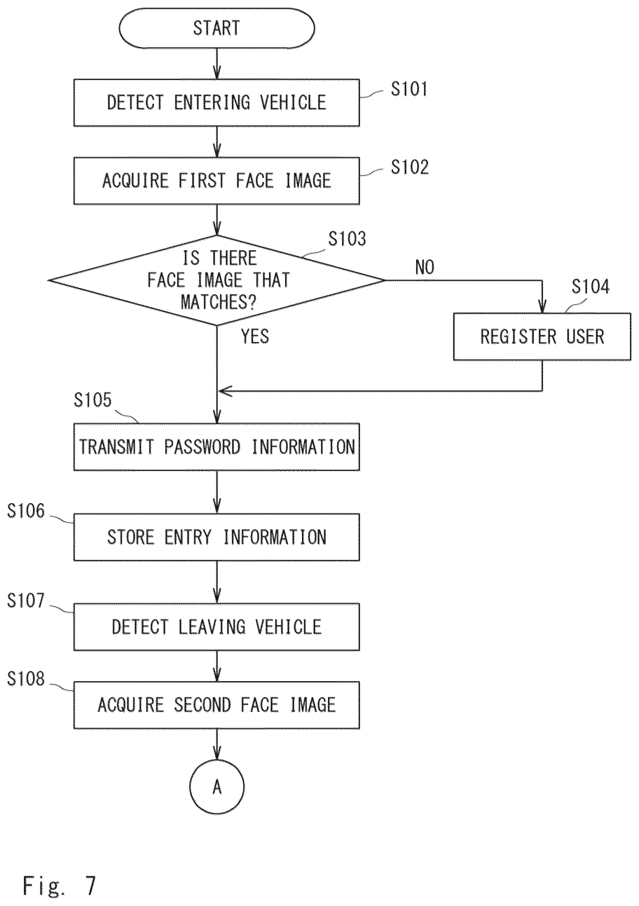

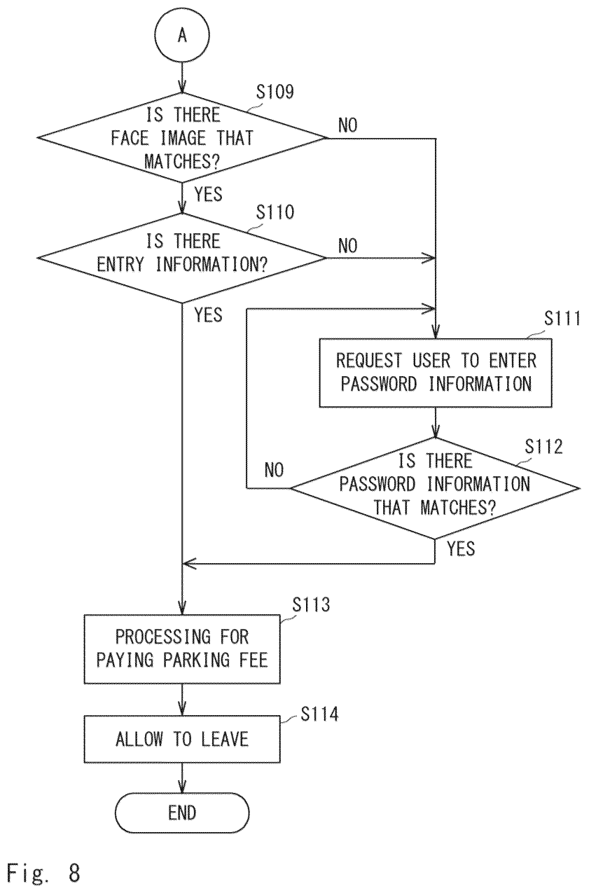

Referring next to FIGS. 7 and 8, a parking lot management method in the parking lot management system 100A according to the first example embodiment will be described.

First, the vehicle sensor unit 201 of the parking lot terminal 200A installed in an entrance of a parking lot detects a vehicle entering the parking lot (Step S101).

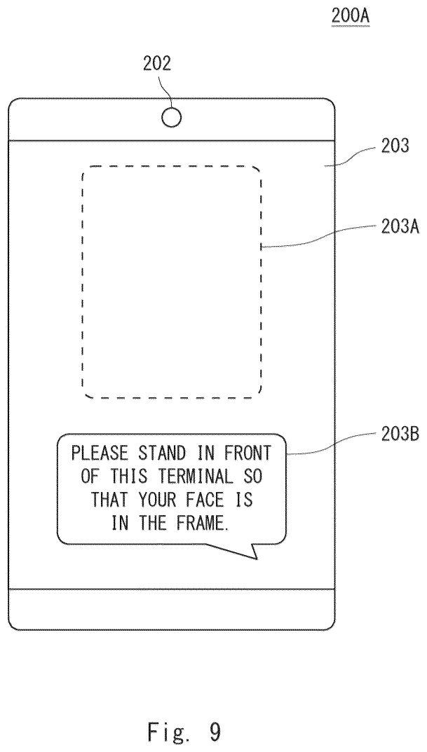

Next, the face image acquisition unit 202 of the parking lot terminal 200A captures a face image of a user who drives a vehicle and acquires a first face image (Step S102). For example, the parking lot terminal 200A is installed in the entrance of the parking lot on the side of the driver's seat of the vehicle, and the face image acquisition unit 202 captures an image of the user's face in a state in which the window near the driver's seat of the vehicle that is temporarily parked at the entrance of the parking lot is lowered. FIG. 9 shows the face image acquisition unit 202 and the display unit 203 of the parking lot terminal 200A installed in the entrance of the parking lot on the side of the driver's seat of the vehicle. The face image acquisition unit 202 may be disposed, for example, on an upper side of the display unit 203, as shown in FIG. 9. Then, the display unit 203 displays an imaging frame 203A for specifying the position of the user's face, a message 203B for acquiring the face image, and so on, and the face image acquisition unit 202 captures the image of the user. Then, the parking lot terminal 200A transmits the parking lot terminal ID of the parking lot terminal 200A, the vehicle detection signal, and the first face image in which the entry flag is set to the server 300A.

Next, the entry processing unit 303 of the server 300A determines whether or not there is registered face information 301B that matches the first face image in the user information storage unit 301 (Step S103).

When there is no registered face information 301B that matches the first face image in the user information storage unit 301 in Step S103 (Step S103; No), the entry processing unit 303 registers the user information (Step S104) and the process proceeds to Step S105.

When there is registered face information 301B that matches the first face image in the user information storage unit 301 in Step S103 (Step S103; Yes), the entry processing unit 303 transmits the temporary password information to the user terminal 400A (Step S105) and stores the entry information in the entry information storage unit 302 (Step S106). Specifically, the entry processing unit 303 stores the parking lot terminal ID received in Step S102, the user ID 301A associated with the registered face information 301B that matches the first face image in the user information storage unit 301, the temporary password information, and the time of entry in the entry information storage unit 302 in such a way that they are associated with one another. Note that the entry processing unit 303 may generate the temporary password information 302C for each parking lot terminal 200A.

Next, the vehicle sensor unit 201 of the parking lot terminal 200A installed in an entrance of a parking lot detects the vehicle leaving the parking lot (Step S107).

Next, the face image acquisition unit 202 of the parking lot terminal 200A captures the face image of the user who drives the vehicle in a method similar to that in Step S102, to acquire a second face image (Step S108). Then, the parking lot terminal 200A transmits the second face image in which the parking lot terminal ID of the parking lot terminal 200A, the vehicle detection signal, and the exit flag are set to the server 300A.

Next, the exit processing unit 305 of the server 300A determines whether or not there is registered face information 301B that matches the second face image in the user information storage unit 301 (Step S109).

In Step S109, when there is registered face information 301B that matches the second face image in the entry information storage unit 302 (Step S109; Yes), the exit processing unit 305 determines whether or not there is entry information of the user at the time of exit in the entry information storage unit 302 (Step S110). Specifically, the exit processing unit 305 determines whether or not the user ID of the user at the time of exit is stored in the entry information storage unit 302. More specifically, the exit processing unit 305 acquires the user ID 301A associated with the registered face information 301B from the user information storage unit 301 as the user ID of the user at the time of exit. Next, the exit processing unit 305 determines whether or not the user ID 301A is included in the user ID 302B stored in the entry information storage unit 302. When the user ID 301A is included in the user ID 302B stored in the entry information storage unit 302 (Step S110; Yes), the exit processing unit 305 determines that there is entry information of the user at the time of exit in the entry information storage unit 302.

When there is no registered face information that matches the second face image in the entry information storage unit 302 in Step S109 (Step S109; No) and there is no entry information of the user at the time of exit in the entry information storage unit 302 in Step S110 (Step S110; No), the exit processing unit 305 requests the user to enter the temporary password information into the parking lot terminal 200A (Step S111).

Next, the exit processing unit 305 determines whether or not there is temporary password information 302C that matches the temporary password information input in Step S111 in the entry information storage unit 302 (Step S112). When the temporary password information 302C is generated in the entry processing for each parking lot terminal 200A, the exit processing unit 305 determines whether or not the acquired temporary password information and the parking lot terminal ID match the temporary password information 302C and the parking lot terminal ID 302A stored in the entry information storage unit 302.

When there is no temporary password information 302C that matches the temporary password information input in Step S111 in Step S112 (Step S112; No), the process returns to the process of Step S111.

When there is temporary password information 302C that matches the temporary password information input in Step S111 in Step S112 (Step S112; Yes), the process proceeds to Step S113.

When there is entry information of the user at the time of exit in the entry information storage unit 302 in Step S110 (Step S110; Yes), the exit processing unit 305 performs the processing for paying the parking fee (Step S113), and the vehicle is allowed to leave (Step S114).

Note that the payment processing in Step S113 may be made by cash. In this case, the settlement information 301D may not be stored in the user information storage unit 301.

With the parking lot management system 100A according to the first example embodiment described above, the user information storage unit 301 stores user information in which at least the user ID 301A, the registered face information 301B of the user, and the destination information 301C of the user terminal 400A owned by the user are associated with one another in advance. Further, the face image acquisition unit 202 of the parking lot terminal 200A acquires a first face image obtained by capturing an image of the user who drives the vehicle entering the parking lot and a second face image obtained by capturing an image of the user who drives the vehicle leaving the parking lot. Further, when the first face image matches the registered face information 301B, the server 300A transmits the temporary password information 302C to the user terminal 400A. Then, when the second face image matches the registered face information 301B and the user ID of the user at the time of exit is not stored in the entry information storage unit 302, the server 300A performs authentication using the temporary password information 302C. In other words, when the user who has his/her vehicle leave the parking lot is the user stored in the user information storage unit 301 in advance and is different from the user who has his/her vehicle enter the parking lot, the server 300A performs authentication using the temporary password information 302C. Therefore, even when the user who has his/her vehicle enter the parking lot is different from the user who has his/her vehicle leave the parking lot, the server 300A may perform payment processing. Accordingly, it is possible to provide a parking lot management system 100A, a parking lot management method, and a non-transitory computer readable medium storing a parking lot management program capable of further improving convenience.

Further, when the second face image does not match the registered face information 301B stored in the user information storage unit 301, the exit processing unit 305 acquires the temporary password information entered by the user into the parking lot terminal 200A, and when the acquired temporary password information matches the temporary password information 302C stored in the entry information storage unit 302, the exit processing unit 305 performs processing for paying the parking fee for the user associated with the temporary password information 302C. Therefore, even when, for example, the user who has his/her vehicle enter the parking lot is different from the user who has his/her vehicle leave the parking lot and the user who has his/her vehicle leave the parking lot is not registered in the user information storage unit 301 in advance, the server 300A may perform payment processing.

Further, the user information storage unit 301 may store registered face information of a plurality of users (for example, registered face information (A) 301B, registered face information (B) 301E) in association with one user ID 301A. Accordingly, for example, when one vehicle is used by a married couple, the husband and his wife do not need to separately register user information in the server 300A in advance.

The entry processing unit 303 further associates the parking lot terminal ID 302A, the user ID 302B, and the temporary password information 302C with the time of entry 302D and stores these associated information items in the entry information storage unit 302. Accordingly, the exit processing unit 305 is able to determine the parking fee based on the time of entry 302D stored in the entry information storage unit 302.

Further, when the vehicle entering the parking lot has been detected by the vehicle sensor unit 201, the entry processing unit 303 determines whether or not the first face image matches the registered face information 301B stored in the user information storage unit 301. The entry processing unit 303 performs processing for authenticating the first face image when the vehicle entering the parking lot has been detected by the vehicle sensor unit 201. It is therefore possible to prevent, for example, when a user who has got out of a vehicle passes in front of the parking lot terminal 200A to retrieve a forgotten item left in the vehicle and thus the face image of this user has been captured, entry processing from being erroneously performed.

Further, when a vehicle leaving the parking lot has been detected by the vehicle sensor unit 201, the exit processing unit 305 determines whether or not the second face image matches the registered face information 301B stored in the user information storage unit 301. The exit processing unit 305 performs processing for authenticating the second face image when a vehicle leaving the parking lot has been detected by the vehicle sensor unit 201. It is therefore possible to prevent, for example, when a user who has got out of a vehicle passes in front of the parking lot terminal 200A to retrieve a forgotten item left in the vehicle and thus the face image of this user has been captured, exit processing from being erroneously performed.

Further, since the parking lot terminal 200A includes the voice recognition unit 204, the user can enter predetermined matters into the parking lot terminal 200A by voice. For example, the user can enter the temporary password information into the parking lot terminal 200A by voice. Accordingly, it is possible to prevent the user from touching the display unit 203, which is a touch display, and to improve the convenience for the user. It is further possible to prevent infectious diseases.

Further, the purchase history storage unit 304 of the server 300A stores a history of a purchase (purchase amount 304C etc.) made by a user who has parked his/her vehicle in the parking lot in a store which is in alliance with the parking lot while the user has his/her vehicle parked in the parking lot in association with the identification information (user ID 304A) on the user. Therefore, the exit processing unit 305 is able to perform processing for discounting the parking fee based on the purchase history stored in the purchase history storage unit 304. Accordingly, it is possible to provide a parking lot management system 100A, a parking lot management method, and a non-transitory computer readable medium storing a parking lot management program with higher convenience.

While the present invention has been described as a hardware configuration in the aforementioned example embodiment, the present invention is not limited thereto. The present invention can implement the process procedure shown in the flowcharts of FIGS. 7 and 8 by causing a Central Processing Unit (CPU) to execute the computer program.

The aforementioned program can be stored using various types of non-transitory computer-readable media and provided to the computer. The non-transitory computer-readable media include various types of tangible recording media. Examples of the non-transitory computer-readable media include magnetic recording media (e.g., a flexible disk, a magnetic tape, or a hard disk drive), magneto-optical recording media (e.g., a magneto-optical disk), CD-Read Only Memory (ROM), CD-R, CD-R/W, semiconductor memories (e.g., a mask ROM, a Programmable ROM (PROM), an Erasable PROM (EPROM), a flash ROM, or a Random Access Memory (RAM)). The program may also be provided to the computer by various types of transitory computer-readable media. Examples of the transitory computer-readable media include an electrical signal, an optical signal, and an electromagnetic wave. The transitory computer-readable media can provide the program to the computer via a wired communication path, such as an electric wire and an optical fiber, or a wireless communication path.

While the present disclosure has been described above with reference to the example embodiment, the present disclosure is not limited to the aforementioned example embodiment. Various changes that may be understood by one skilled in the art may be made to the configurations and the details of the present disclosure within the scope of the present disclosure.

When, for example, one piece of registered face information 301B is stored in the user information storage unit 301 in such a way that this registered face information 301B is associated with user IDs 301A of a plurality of users, there are a plurality of pieces of registered face information 301B that match the first face image acquired by the face image acquisition unit 202. That is, the entry processing unit 303 ends up detecting, from the user information storage unit 301, a plurality of user IDs 301A associated with the registered face information 301B that matches the first face image. Therefore, in this case, the entry processing unit 303 causes the display unit 203 of the parking lot terminal 200A to display the plurality of detected user IDs 301A so that they can be selected, and allows the user to select with which user ID 301A he/she uses to enter the parking lot.

Further, when one piece of registered face information 301B is stored in the user information storage unit 301 in such a way that this registered face information 301B is associated with user IDs 301A of a plurality of users, there may be a case where one user has a first vehicle enter a parking lot with a first user ID 301A and has a second vehicle enter the parking lot with a second user ID 301A. In this case, when the first vehicle or the second vehicle leaves the parking lot, the exit processing unit 305 detects, from the user information storage unit 301, a plurality of user IDs 301A associated with registered face information that matches the second face image. Then, the exit processing unit 305 may detect, from the entry information storage unit 302, a plurality of user IDs 02B the same as the plurality of user IDs 301A. Therefore, in this case, the exit processing unit 305 may cause the display unit 203 of the parking lot terminal 200A to display the plurality of detected user IDs 302B so that they can be selected, and allow the user to select with which user ID 302B he/she uses to leave the parking lot. Alternatively, the exit processing unit 305 may acquire the temporary password information 302C entered by the user into the parking lot terminal 200A and perform payment processing based on the acquired temporary password information 302C.

Further, the parking lot management system, the parking lot management method, the non-transitory computer readable medium storing the parking lot management program according to the present invention may be applied not only to an hourly parking lot but also to a parking lot of an apartment building, a parking lot of a factory, and so on.

The whole or part of the example embodiments disclosed above can be described as, but not limited to, the following supplementary notes.

### Supplementary Note 1

A parking lot management system comprising:
a parking lot terminal installed in a parking lot, a user terminal owned by a user, and a server that can communicate with the parking lot terminal and the user terminal, wherein
the parking lot terminal comprises:
a face image acquisition unit configured to acquire a first face image obtained by capturing an image of a user who drives a vehicle entering the parking lot and a second face image obtained by capturing an image of a user who drives a vehicle leaving the parking lot, wherein
the server comprises:
a user information storage unit configured to store at least identification information on a user, registered face information of the user, and destination information of the user terminal owned by the user in association with one another in advance;
an entry processing unit configured to determine, when a vehicle enters the parking lot, whether or not the first face image matches the registered face information stored in the user information storage unit, and transmit, when they match each other, temporary password information to the user terminal and store, as entry information, at least the identification information and the temporary password information associated with each other in an entry information storage unit; and
an exit processing unit configured to determine, when a vehicle leaves the parking lot, whether or not the second face image matches the registered face information stored in the user information storage unit, perform, when they match each other and the identification information on the user at the time of exit is stored in the entry information storage unit, processing for paying a parking fee for the user associated with the registered face information, acquire, when they match each other and the identification information on the user at the time of exit is not stored in the entry information storage unit, the temporary password information input by the user on the parking lot terminal, and perform, when the acquired temporary password information matches the temporary password information stored in the entry information storage unit, processing for paying the parking fee for the user associated with the temporary password information.

### Supplementary Note 2

The parking lot management system according to Supplementary Note 1, wherein the exit processing unit acquires, when the second face image does not match the registered face information stored in the user information storage unit, the temporary password information input by a user on the parking lot terminal, and performs, when the acquired temporary password information matches the temporary password information stored in the entry information storage unit, processing for paying the parking fee for the user associated with the temporary password information.

### Supplementary Note 3

The parking lot management system according to Supplementary Note 1 or 2, wherein
the user information storage unit stores the registered face information of a plurality of users in association with one piece of the identification information and one piece of the destination information in advance, and
the entry processing unit determines, when a vehicle enters the parking lot, whether or not the first face image matches any one of the plurality of pieces of registered face information stored in the user information storage unit.

### Supplementary Note 4

The parking lot management system according to any one of Supplementary Notes 1 to 3, wherein
the entry processing unit stores, when the first face image matches the registered face information stored in the user information storage unit, the identification information and the temporary password information further associated with a time of entry in the entry information storage unit, and
the exit processing unit performs processing for paying the parking fee based on the time of entry stored in the entry information storage unit.

### Supplementary Note 5

The parking lot management system according to any one of Supplementary Notes 1 to 4, wherein
the parking lot terminal further comprises a vehicle sensor unit configured to detect a vehicle entering the parking lot and a vehicle leaving the parking lot,
the entry processing unit determines, when the vehicle entering the parking lot has been detected by the vehicle sensor unit, whether or not the first face image matches the registered face information stored in the user information storage unit, and
the exit processing unit determines, when the vehicle leaving the parking lot has been detected by the vehicle sensor unit, whether or not the second face image matches the registered face information stored in the user information storage unit.

### Supplementary Note 6

The parking lot management system according to any one of Supplementary Notes 1 to 5, wherein
the parking lot terminal further comprises a voice recognition unit configured to recognize the user's voice, and
the exit processing unit acquires the temporary password information that has been input by a user on the parking lot terminal by a voice and has been recognized by the voice recognition unit.

### Supplementary Note 7

The parking lot management system according to any one of Supplementary Notes 1 to 6, wherein
the server further comprises a purchase history storage unit configured to store a history of purchase made by a user who has parked his/her vehicle in the parking lot in a store which is in alliance with the parking lot while the user has his/her vehicle parked in the parking lot in association with the identification information on the user, and
the exit processing unit determines the parking fee further based on the purchase history stored in the purchase history storage unit.

### Supplementary Note 8

A parking lot management method, wherein
a server that can communicate with a parking lot terminal installed in a parking lot and a user terminal owned by a user;
stores at least identification information on a user, registered face information of the user, and destination information of the user terminal owned by the user in association with one another in advance;
determines, when a vehicle enters the parking lot, whether or not a first face image obtained by capturing an image of the user who drives the vehicle entering the parking lot, the first face image being acquired by the parking lot terminal, matches the registered face information, and transmits, when they match each other, temporary password information to the user terminal and stores, as entry information, at least the identification information and the temporary password information associated with each other; and
determines, when a vehicle leaves the parking lot, whether or not a second face image obtained by capturing an image of the user who drives the vehicle leaving the parking lot, the second face image being acquired by the parking lot terminal, matches the registered face information, performs, when they match each other and the identification information on the user at the time of exit is included in the entry information, processing for paying a parking fee for the user associated with the registered face information, acquires, when they match each other and the identification information on the user at the time of exit is not included in the entry information, the temporary password information input by the user on the parking lot terminal, and performs, when the acquired temporary password information matches the stored temporary password information, processing for paying the parking fee for the user associated with the temporary password information.

### Supplementary Note 9

The parking lot management method according to Supplementary Note 8, wherein the server acquires, when the second face image does not match the registered face information, the temporary password information input by a user on the parking lot terminal and performs, when the acquired temporary password information matches the stored temporary password information, processing for paying the parking fee for the user associated with the temporary password information.

### Supplementary Note 10

The parking lot management method according to Supplementary Note 8 or 9, wherein the server:
stores the registered face information of a plurality of users in association with one piece of the identification information and one piece of the destination information in advance; and
determines, when a vehicle enters the parking lot, whether or not the first face image matches any one of the plurality of pieces of registered face information.

### Supplementary Note 11

The parking lot management method according to any one of Supplementary Notes 8 to 10, wherein the server:
stores, when the vehicle enters the parking lot and the first face image matches the registered face information, the identification information and the temporary password information further associated with a time of entry; and
performs processing for paying the parking fee based on the time of entry when a vehicle leaves the parking lot.

### Supplementary Note 12

The parking lot management method according to any one of Supplementary Notes 8 to 11, wherein the server:
determines, when the vehicle entering the parking lot has been detected by the parking lot terminal, whether or not the first face image matches the registered face information; and
determines, when the vehicle leaving the parking lot has been detected by the parking lot terminal, whether or not the second face image matches the registered face information.

### Supplementary Note 13

The parking lot management method according to any one of Supplementary Notes 8 to 12, wherein the server acquires the temporary password information that has been input by a user on the parking lot terminal by a voice and has been recognized by the parking lot terminal.

### Supplementary Note 14

The parking lot management method according to any one of Supplementary Notes 8 to 13, wherein the server:
stores a history of purchase made by a user who has parked his/her vehicle in the parking lot in a store which is in alliance with the parking lot while the user has his/her vehicle parked in the parking lot in association with the identification information on the user; and
determines the parking fee further based on the purchase history.

### Supplementary Note 15

A non-transitory computer readable medium storing a parking lot management program causing a server that can communicate with a parking lot terminal installed in a parking lot and a user terminal owned by a user to execute:
processing for storing at least identification information on a user, registered face information of the user, and destination information of the user terminal owned by the user in association with one another;
processing for determining, when a vehicle enters the parking lot, whether or not a first face image obtained by capturing an image of the user who drives the vehicle entering the parking lot, the first face image being acquired by the parking lot terminal, matches the registered face information, and transmitting, when they match each other, temporary password information to the user terminal and storing, as entry information, at least the identification information and the temporary password information associated with each other; and
processing for determining, when a vehicle leaves the parking lot, whether or not a second face image obtained by capturing an image of the user who drives the vehicle leaving the parking lot, the second face image being acquired by the parking lot terminal, matches the registered face information, performing, when they match each other and the identification information on the user at the time of exit is included in the entry information, processing for paying a parking fee for the user associated with the registered face information, acquiring, when they match each other and the identification information on the user at the time of exit is not included in the entry information, the temporary password information input by the user on the parking lot terminal, and performing, when the acquired temporary password information matches the stored temporary password information, processing for paying the parking fee for the user associated with the temporary password information.

### Supplementary Note 16

The non-transitory computer readable medium storing the parking lot management program according to Supplementary Note 15, causing the server to execute acquiring, when the second face image does not match the registered face information, the temporary password information input by a user on the parking lot terminal, and performing, when the acquired temporary password information matches the stored temporary password information, processing for paying the parking fee for the user associated with the temporary password information.

### Supplementary Note 17

The non-transitory computer readable medium storing the parking lot management program according to Supplementary Note 15 or 16, causing the server to execute:
processing for storing the registered face information of a plurality of users in association with one piece of the identification information and one piece of the destination information in advance; and
determining, when a vehicle enters the parking lot, whether or not the first face image matches any one of the plurality of pieces of registered face information.

### Supplementary Note 18

The non-transitory computer readable medium storing the parking lot management program according to any one of Supplementary Notes 15 to 17, causing the server to execute:
processing for storing, when a vehicle enters the parking lot and the first face image matches the registered face information, the identification information and the temporary password information further associated with a time of entry; and
processing for performing processing for paying the parking fee based on the time of entry when a vehicle leaves the parking lot.

### Supplementary Note 19

The non-transitory computer readable medium storing the parking lot management program according to any one of Supplementary Notes 15 to 18, causing the server to execute:
processing for determining, when the vehicle entering the parking lot has been detected by the parking lot terminal, whether or not the first face image matches the registered face information; and
processing for determining, when the vehicle leaving the parking lot has been detected by the parking lot terminal, whether or not the second face image matches the registered face information.

### Supplementary Note 20

The non-transitory computer readable medium storing the parking lot management program according to any one of Supplementary Notes 15 to 19, causing the server to execute processing for acquiring the temporary password information that has been input by a user on the parking lot terminal by a voice and has been recognized by the parking lot terminal.

### Supplementary Note 21

The non-transitory computer readable medium storing the parking lot management program according to any one of Supplementary Notes 15 to 20, causing the server to execute:
processing for storing a history of purchase made by a user who has parked his/her vehicle in the parking lot in a store which is in alliance with the parking lot while the user has his/her vehicle parked in the parking lot in association with the identification information on the user; and
processing for determining the parking fee further based on the purchase history.

### INDUSTRIAL APPLICABILITY

It is possible to provide a parking lot management system, a parking lot management method, and a non-transitory computer readable medium storing a parking lot management program capable of further improving convenience.

### REFERENCE SIGNS LIST

100, 100A PARKING LOT MANAGEMENT SYSTEM
200, 200A PARKING LOT TERMINAL
201 VEHICLE SENSOR UNIT
202 FACE IMAGE ACQUISITION UNIT
203 DISPLAY UNIT
204 VOICE RECOGNITION UNIT
300, 300A SERVER
301 USER INFORMATION STORAGE UNIT
302 ENTRY INFORMATION STORAGE UNIT
303 ENTRY PROCESSING UNIT
304 PURCHASE HISTORY STORAGE UNIT
305 EXIT PROCESSING UNIT
400, 400A USER TERMINAL

What is claimed is:

1. A parking lot management system comprising:
a parking lot terminal installed in a parking lot, a user terminal owned by a user, and a server that can communicate with the parking lot terminal and the user terminal, wherein
the parking lot terminal comprises:
a memory storing instructions; and
one or more processors configured to execute the instructions to:
acquire a first face image obtained by capturing an image of a user who drives a vehicle entering the parking lot and a second face image obtained by capturing an image of a user who drives a vehicle exiting the parking lot, and
the server comprises:
a storage configured to store at least identification information on a user, registered face information of the user, and destination information of the user terminal owned by the user in association with one another in advance;
a memory storing instructions; and
one or more processors configured to execute the instructions to:
determine, in a case that a vehicle enters the parking lot, whether or not the first face image matches the registered face information stored in the storage;
transmit, in a case that the first face image matches the registered face information, temporary password information to the user terminal;
store, as entry information, at least the identification information and the temporary password information associated with each other in the storage;
determine, in a case that a vehicle exits the parking lot, whether or not the second face image matches the registered face information stored in the storage;
perform, in a case that the second face image matches the registered face information and the identification information on the exiting user is stored in the storage as the entry information, processing for paying a parking fee for the user associated with the registered face information;
acquire, in a case that the second face image matches the registered face information and the identification information on the exiting user is not stored in the storage as the entry information, the temporary password information input by the user on the parking lot terminal; and
perform, in a case that the acquired temporary password information matches the temporary password information stored in the storage, processing for paying the parking fee for the user associated with the temporary password information.

2. The parking lot management system according to claim 1, wherein the one or more processors of the server configured to execute the instructions to:
acquire, in a case that the second face image does not match the registered face information stored in the storage, the temporary password information input by a user on the parking lot terminal; and
perform, in a case that the acquired temporary password information matches the temporary password information stored in the storage, processing for paying the parking fee for the user associated with the temporary password information.

3. The parking lot management system according to claim 1, wherein
the storage stores the registered face information of a plurality of users in association with one piece of the identification information and one piece of the destination information in advance, and
the one or more processors of the server configured to execute the instructions to determine, in a case that a vehicle enters the parking lot, whether or not the first face image matches any one of the plurality of pieces of registered face information stored in the storage.

4. The parking lot management system according to claim 1, wherein
the one or more processors of the server configured to execute the instructions to:
store, in a case that the first face image matches the registered face information stored in the storage, the identification information and the temporary password information further associated with a time of entry in the storage; and
perform processing for paying the parking fee based on the time of entry stored in the storage.

5. The parking lot management system according to claim 1 4, wherein
the parking lot terminal further comprises a vehicle sensor unit configured to detect a vehicle entering the parking lot and a vehicle exiting the parking lot,
the one or more processors of the server configured to execute the instructions to:
determine, in a case that the vehicle entering the parking lot has been detected by the vehicle sensor unit, whether or not the first face image matches the registered face information stored in the storage; and
determine, in a case that the vehicle exiting the parking lot has been detected by the vehicle sensor unit, whether or not the second face image matches the registered face information stored in the storage.

6. The parking lot management system according to claim 1, wherein
the one or more processors of the parking lot terminal configured to execute the instructions to recognize the user's voice, and
the one or more processors of the server configured to execute the instructions to acquire the temporary password information that has been input by a user on the parking lot terminal by a voice and has been recognized by the parking lot terminal.

7. The parking lot management system according to claim 1, wherein
the storage stores a history of purchase made by a user who has parked his/her vehicle in the parking lot in a store which is in alliance with the parking lot while the user has his/her vehicle parked in the parking lot in association with the identification information on the user, and
the one or more processors of the server configured to execute the instructions to determine the parking fee further based on the purchase history stored in the storage.

8. A parking lot management method, wherein
a server that can communicate with a parking lot terminal installed in a parking lot and a user terminal owned by a user:
stores at least identification information on a user, registered face information of the user, and destination information of the user terminal owned by the user in association with one another in advance;
determines, in a case that a vehicle enters the parking lot, whether or not a first face image obtained by capturing an image of the user who drives the vehicle entering the parking lot, the first face image being acquired by the parking lot terminal, matches the registered face information; and
transmits, in a case that the first face image matches the registered face information, temporary password information to the user terminal;
stores, as entry information, at least the identification information and the temporary password information associated with each other;
determines, in a case that a vehicle exits the parking lot, whether or not a second face image obtained by capturing an image of the user who drives the vehicle exiting the parking lot, the second face image being acquired by the parking lot terminal, matches the registered face information;
performs, in a case that the second face image matches the registered face information and the identification information on the exiting user is included in the entry information, processing for paying a parking fee for the user associated with the registered face information;
acquires, in a case that the second face image matches the registered face information and the identification information on the exiting user is not included in the entry information, the temporary password information input by the user on the parking lot terminal; and
performs, in a case that the acquired temporary password information matches the stored temporary password information, processing for paying the parking fee for the user associated with the temporary password information.

9. The parking lot management method according to claim 8, wherein the server;
acquires, in a case that the second face image does not match the registered face information, the temporary password information input by a user on the parking lot terminal; and
performs, in a case that the acquired temporary password information matches the stored temporary password information, processing for paying the parking fee for the user associated with the temporary password information.

10. The parking lot management method according to claim 8, wherein the server:
stores the registered face information of a plurality of users in association with one piece of the identification information and one piece of the destination information in advance; and
determines, in a case that a vehicle enters the parking lot, whether or not the first face image matches any one of the plurality of pieces of registered face information.

11. The parking lot management method according to claim 8, wherein the server:
stores, in a case that the vehicle enters the parking lot and the first face image matches the registered face information, the identification information and the temporary password information further associated with a time of entry; and
performs processing for paying the parking fee based on the time of entry in a case that a vehicle exits the parking lot.

12. The parking lot management method according to claim 8, wherein the server:
determines, in a case that the vehicle entering the parking lot has been detected by the parking lot terminal, whether or not the first face image matches the registered face information; and
determines, in a case that the vehicle exiting leaving the parking lot has been detected by the parking lot terminal, whether or not the second face image matches the registered face information.

13. The parking lot management method according to claim 8, wherein the server acquires the temporary password information that has been input by a user on the parking lot terminal by a voice and has been recognized by the parking lot terminal.

14. The parking lot management method according to claim 8, wherein the server:
stores a history of purchase made by a user who has parked his/her vehicle in the parking lot in a store which is in alliance with the parking lot while the user has his/her vehicle parked in the parking lot in association with the identification information on the user; and
determines the parking fee further based on the purchase history.

15. A non-transitory computer readable medium storing a parking lot management program causing a server that can communicate with a parking lot terminal installed in a parking lot and a user terminal owned by a user to execute:
processing for storing at least identification information on a user, registered face information of the user, and destination information of the user terminal owned by the user in association with one another;
processing for determining, in a case that a vehicle enters the parking lot, whether or not a first face image obtained by capturing an image of the user who drives the vehicle entering the parking lot, the first face image being acquired by the parking lot terminal, matches the registered face information;
processing for transmitting, in a case that the first face image matches the registered face information, temporary password information to the user terminal;
processing for storing, as entry information, at least the identification information and the temporary password information associated with each other;
processing for determining, in a case that a vehicle exits the parking lot, whether or not a second face image obtained by capturing an image of the user who drives the vehicle exiting the parking lot, the second face image being acquired by the parking lot terminal, matches the registered face information;;
processing for performing, in a case that the second face image matches the registered face information and the identification information on the exiting user is included in the entry information, processing for paying a parking fee for the user associated with the registered face information;
processing for acquiring, in a case that the second face image matches the registered face information and the identification information on the exiting user is not included in the entry information, the temporary password information input by the user on the parking lot terminal; and
processing for performing, in a case that the acquired temporary password information matches the stored temporary password information, processing for paying the parking fee for the user associated with the temporary password information.

16. The non-transitory computer readable medium storing the parking lot management program according to claim 15, causing the server to execute;
processing for acquiring, in a case that the second face image does not match the registered face information, the temporary password information input by a user on the parking lot terminal;, and
processing for performing, in a case that the acquired temporary password information matches the stored temporary password information, processing for paying the parking fee for the user associated with the temporary password information.

17. The non-transitory computer readable medium storing the parking lot management program according to claim 15, causing the server to execute:
processing for storing the registered face information of a plurality of users in association with one piece of the identification information and one piece of the destination information in advance; and
determining, in a case that a vehicle enters the parking lot, whether or not the first face image matches any one of the plurality of pieces of registered face information.

18. The non-transitory computer readable medium storing the parking lot management program according to claim 15, causing the server to execute:
processing for storing, in a case that a vehicle enters the parking lot and the first face image matches the registered face information, the identification information and the temporary password information further associated with a time of entry; and
processing for performing processing for paying the parking fee based on the time of entry in a case that a vehicle exits the parking lot.

19. The non-transitory computer readable medium storing the parking lot management program according to claim 15, causing the server to execute:
processing for determining, in a case that the vehicle entering the parking lot has been detected by the parking lot terminal, whether or not the first face image matches the registered face information; and
processing for determining, in a case that the vehicle exiting the parking lot has been detected by the parking lot terminal, whether or not the second face image matches the registered face information.

20. The non-transitory computer readable medium storing the parking lot management program according to claim 15, causing the server to execute processing for acquiring the temporary password information that has been input by a user on the parking lot terminal by a voice and has been recognized by the parking lot terminal.

21. (canceled)
